(19) United States
(12) Patent Application Publication
(10) Pub. No.: US 2026/0267287 A1
(43) Pub. Date: Sep. 10, 2026

(54) TIMEPIECE MOVEMENT COMPRISING AN AUTOMATIC WINDING MECHANISM

(71) Applicant: MANUFACTURE D'HORLOGERIE AU DEMARS PIGUET SA, Le Brassus (CH)

(72) Inventors: Laurent CALAME, La Sagne (CH); Eric MAGNIN-FEYSOT, Montlebon (FR)

(21) Appl. No.: 19/165,705

(22) PCT Filed: Mar. 14, 2024
(86) PCT No.: PCT/IB2024/052498

§ 371 Date: Sep. 16, 2025

(30) Foreign Application Priority Data
Mar. 17, 2023 (EP) 23162695.3

(51) Int. Cl. G04B 5/18; G04B 5/10; G04B 45/02

(52) U.S. Cl. CPC G04B 5/18; G04B 5/10; G04B 45/02

(57) ABSTRACT

The present invention relates to a watch movement comprising in particular a base, a gear train, a barrel, and an automatic winding mechanism for winding the barrel. The winding mechanism comprises a winding weight mounted in an articulated manner on the base by way of rotary arms so that the winding weight can perform a circular translation movement. The winding mechanism further comprises transmission means arranged to transmit the movement of the winding weight to the barrel. The winding weight is connected to the rotary arms so as to constrain the circular translation movement of said weight in a plane parallel to the general plane of the watch movement. The rotary arms are moreover free to pivot through 360°.

### TECHNICAL FIELD

The present invention relates to the field of watchmaking and, more specifically, to a watch movement comprising an automatic winding mechanism. This mechanism includes a winding weight arranged to perform a circular translational movement.

### BACKGROUND ART

Automatic winding mechanisms most often use a semi-circular oscillating weight, pivotally mounted at the centre of the watch movement along an axis perpendicular to its general plane. A drawback of this type of oscillating weight lies in its position on the case-back side of the watch, at least partially concealing the watch movement. Such an arrangement is not always desirable, especially when the case back is made of sapphire crystal in order to make an original visual aspect of the movement visible.

In order to address this issue, CH706350 proposes a watch movement comprising a frame, various components including a barrel and gear trains mounted on the frame, as well as an automatic winding mechanism for winding the barrel. This winding mechanism includes a winding weight, and transmission means arranged to transfer the movement of the winding weight to the barrel to wind it. The winding weight is articulated on at least two arms pivotally mounted on the frame. The winding weight is further arranged to perform a circular translational movement that can be complete around the frame in a plane perpendicular to the general plane of the watch movement.

It is therefore necessary to provide a significant volume within the watch case to allow the movements of the winding weight in the aforementioned perpendicular plane. This impacts the thickness of the watch case, which must be sufficient to ensure that the amplitude of the mass's movements enables effective winding of the barrel.

CH157093 and CH168493 disclose another example of an automatic winding watch movement comprising a non-conventional oscillating weight. The winding mechanism includes a frame comprising, in particular, a barrel and a winding weight. The winding weight is connected to the frame by multiple arms, whose axis of rotation is parallel to the general plane of the watch movement. The distance between the winding weight and the frame varies depending on the position of the weight. Consequently, as with CH706350, it is necessary to provide sufficient volume within the watch case to accommodate the movement of the winding weight.

Moreover, the plane in which the winding weight oscillates in the aforementioned mechanisms is not optimal in relation to the most common general movements of a wearer's arm, which are swinging motions along the body. This has a significant impact on the winding efficiency of the barrel.

CH707942A2 relates to an automatic winding mechanism for a watch movement comprising two winding weights connected to a barrel in order to wind it through their rotational movement. The two winding weights are mechanically connected to each other through a rigid synchronization link in the form of a connecting rod.

An aim of the present invention is therefore to propose a watch movement comprising an automatic winding mechanism that does not conceal the movement while at least partially solving the aforementioned problems of the prior art.

### BRIEF SUMMARY OF THE INVENTION

This aim is achieved by a watch movement comprising in particular a base, a gear train, a barrel, and an automatic winding mechanism for winding the barrel. The winding mechanism comprises a winding weight mounted in an articulated manner on the base by way of rotary arms so that the winding weight can perform a circular translation movement. The winding mechanism further comprises transmission means arranged to transmit the movement of the winding weight to the barrel. The winding weight is connected to the rotary arms so as to constrain the circular translation movement of the weight in a plane parallel to the general plane of the watch movement. The rotary arms are moreover free to pivot through 360°.

According to an embodiment, the watch movement further comprises a frame connected to the winding weight or formed as a single piece with the weight. The rotary arms are pivotally connected to the frame. The rotary arms are further arranged to pivot in a plane located between the frame and the base.

According to an embodiment, the winding weight comprises an unbalance.

According to an embodiment, the frame comprises at least a first and a second fixing part to which the rotary arms are connected, and at least a first and a second support, each supporting an inertia mass of the winding weight. The inertia masses together form the unbalance of the winding weight. The fixing parts and supports are each arranged alternately on the frame around a central part of the watch movement.

According to an embodiment, the inertia masses are arranged on a single side of the frame.

According to an embodiment, the first and second fixing parts are each connected to the base by two rotary arms.

According to an embodiment, each inertia mass has an outer face intended to be mounted opposite a portion of the middle case of a watch case when the watch movement is mounted in the case, and an inner face opposite the outer face. The inner face of at least one of the inertia masses includes a recess to partially surround at least one component of the watch movement, in particular a gear train, when a circular translational movement is applied to the winding weight.

According to an embodiment, at least one of the inertia masses comprises a cutout for the passage of a control stem, such as a time-setting stem.

According to an embodiment, the winding weight is articulated on the base via three or four rotary arms.

According to an embodiment, the winding weight comprises three inertia masses, each arranged between two rotary arms.

According to an embodiment, the transmission means comprise a gear train engaged with the barrel ratchet. At least one of the rotary arms is fixed to a drive shaft comprising a drive wheel in mesh with the gear train and arranged to be driven in rotation by the rotation of said at least one rotary arm.

According to an embodiment, the transmission means comprise a pull lever and a push lever. The pull and push levers comprise at a first end a pawl configured to alternately pull and push a tooth of the barrel ratchet or of a wheel in mesh with the barrel ratchet, in such a way that the barrel ratchet is driven in rotation in one direction only. Each of the pull and push levers comprises a second end fixed to one of the rotary arms.

According to an embodiment, at least one elastic member is fixed to the winding weight. This elastic member is arranged to act on an actuatable part of the traction lever and of the push lever in order to urge their respective pawls against the barrel ratchet or the wheel in mesh with the ratchet.

Another aspect of the invention relates to a timepiece comprising the watch movement according to one of the embodiments mentioned above.

### BRIEF DESCRIPTION OF THE FIGURES

Examples of embodiments of the invention are provided in the description illustrated by the accompanying figures, in which:

FIG. 1 shows a perspective view of a watch movement comprising a winding weight according to an embodiment of the invention;

FIG. 2 shows a perspective view of the watch movement of FIG. 1 from a different orientation;

FIG. 3 shows a view similar to FIG. 2 without the winding weight;

FIGS. 4a and 4b show a perspective view of the winding weight from FIG. 1 in a first and a second orientation;

FIG. 5 shows a top view of the watch movement from FIG. 1 on the side of the winding weight;

FIG. 6 shows a cross-sectional view of the watch movement from FIG. 5 along line A-A;

FIG. 7 shows a perspective view of the kinematic chain connecting the winding weight to the barrel of the watch movement;

FIG. 8 shows an enlarged view of the kinematic chain from FIG. 7;

FIGS. 9a to 9d illustrate a sequence of circular translational movement of the winding weight;

FIG. 10a shows a simplified view of a watch movement comprising means for transmitting movement of the weight to the barrel according to another embodiment, and

FIG. 10b shows a similar view to FIG. 10a without the winding weight.

### EXAMPLES OF EMBODIMENTS OF THE INVENTION

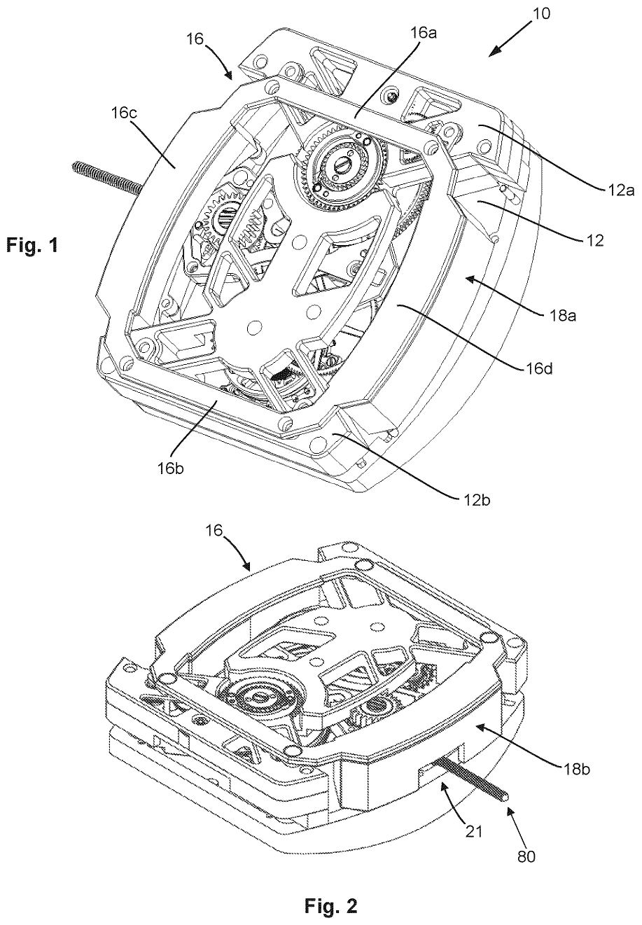

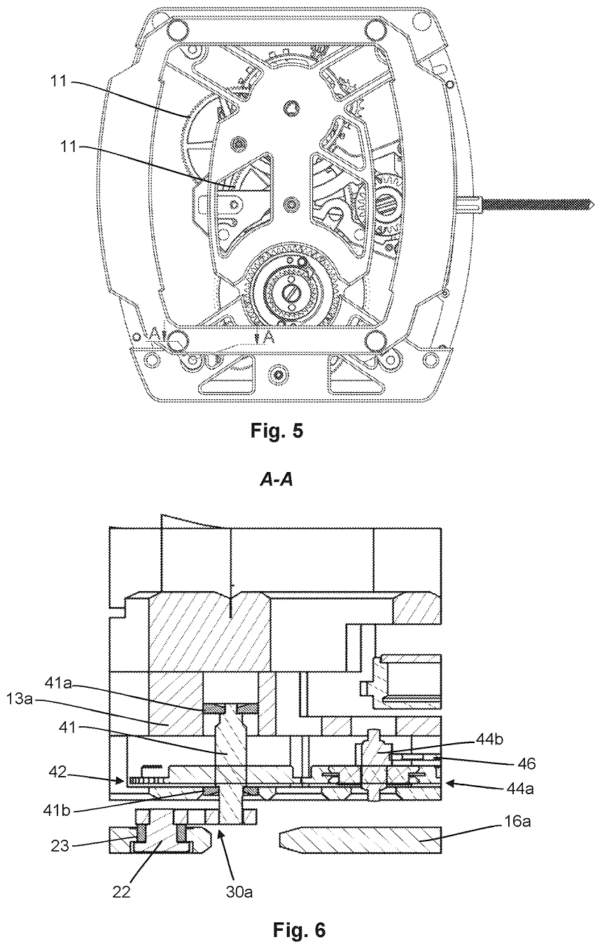

Referring to FIGS. 1 to 8, the watch movement 10 comprises a base 12, 12a, 12b, various components, including a barrel 60, gears 11, and an automatic winding mechanism to wind the barrel 60. The winding mechanism comprises a winding weight 14 connected to the base 12 by several rotary arms, for example, three or four rotary arms 30a, 30b, 30c, 30d, so that a circular translational movement can be imparted to the winding weight 14 in a single plane, the orientation of which corresponds to the general plane of the watch movement. In this application, the term “winding weight” refers to a weight with sufficient inertia to be capable of fulfilling its primary function, which is to provide energy to the winding mechanism.

The circular translational movement of the winding weight 14 enables a reduction in the thickness of the watch movement compared to existing automatic winding mechanisms with circular translation mentioned earlier. This also optimizes the winding of the barrel, particularly because this plane aligns with the natural swinging motion of a wristwatch wearer's arm while walking.

To this end, as seen in FIGS. 4a and 4b, the winding weight 14 comprises a frame 16 and two separate weights 18a, 18b, hereinafter referred to as inertia masses, which are attached to the frame 16 and together create an unbalance to optimize the initiation of the winding weight movement and, consequently, the winding of the barrel. In an alternative embodiment, the two inertia masses 18a, 18b and the frame 16 may be formed as a single unit. The frame 16 has a substantially rectangular or square shape and is arranged around a central part of the watch movement 10 to make this central part visible through a transparent case back of a watch case enclosing the movement. The transparent case back may, in particular, be made of sapphire crystal.

More specifically, the frame 16 includes two fixing parts 16a, 16b arranged opposite each other on either side of the central part of the watch movement, as well as a first and a second support 16c, 16d, to which the two inertia masses 18a, 18b of the winding weight 14 are fixed. Preferably, the two supports 16c, 16d constitute supporting surfaces for the inertia masses, extending opposite each other and substantially perpendicular to the two fixing parts 16a, 16b. Each fixing part comprises two counterbores 17a, 17b at the openings of two screw holes. Screws 22 are inserted into the screw holes, with their ends screwed into holes in each rotary arm and their heads embedded in the counterbore 17, as illustrated in FIG. 6. A bearing 23 is arranged between the screw body and the screw hole to ensure the rotation of the frame 16 relative to the screws 22.

In an unillustrated embodiment, the winding weight may comprise three inertia masses, each positioned between two rotary arms that connect the frame to the base of the watch movement. To this end, the frame may comprise three fixing parts, each connected to the base by a rotary arm. These three fixing parts are arranged around the central part of the watch movement, alternating with three supports to which the three inertia masses are fixed. In an alternative embodiment, the counterweights may be integrally formed with the three supports of the frame. While the shape of the frame is substantially rectangular according to the illustrated embodiment, this frame could have a substantially annular shape, according to an alternative embodiment.

In another unillustrated embodiment, the winding weight may be devoid of an unbalance. More specifically, the winding weight can consist of a uniform mass block, for example, in the form of a disk, with sufficient thickness to serve as a winding weight. Indeed, it is the off-center or offset movement induced by the rotary arms that gives it an imbalance arrangement comparable to an unbalance.

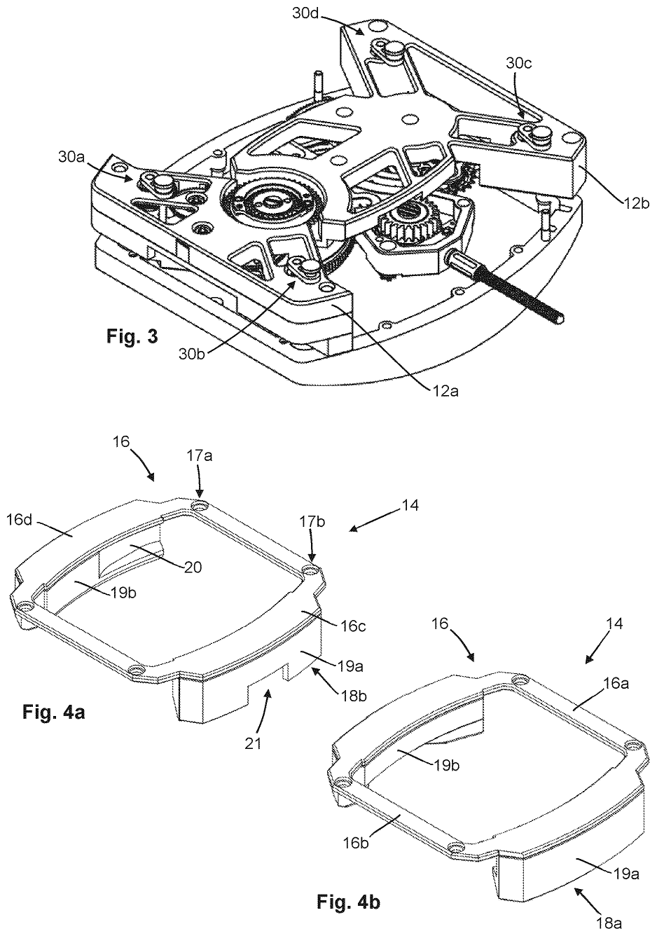

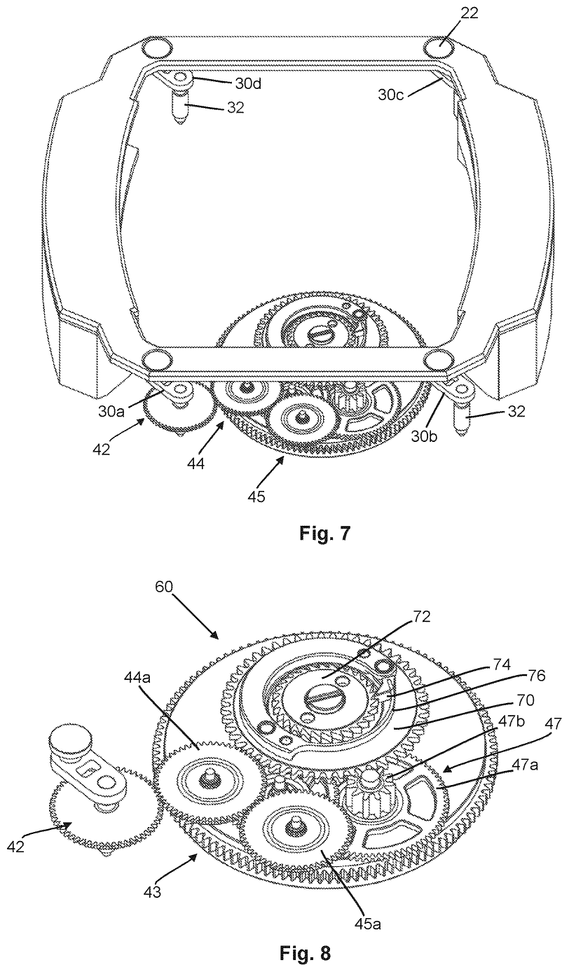

According to the example in FIG. 7, three arms 30b, 30c, 30d of the four rotary arms can be mounted on simple pivots 32, while the fourth arm 30a is mounted on a drive shaft as described in more detail below. The four rotary arms are mounted on two bridges 12a, 12b (FIG. 1) located on opposite sides of the watch movement 10, so that these rotary arms are positioned near the four corners of the watch movement, as can be seen in FIG. 3.

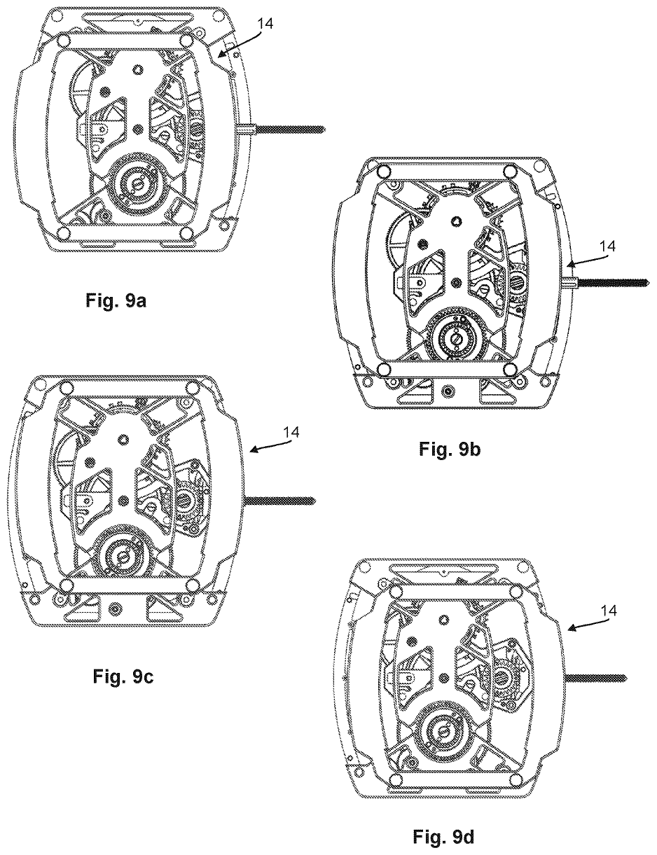

The axis of each pivot 32 extends perpendicular to the general plane of the watch movement so that the four rotary arms can pivot in a plane whose orientation is identical to the general plane of the watch movement, thereby constraining the circular translational movements within this plane. Each rotating arm 30a, 30b, 30c, 30d is further arranged so that it can rotate freely by 360°, particularly in a plane located between the frame and the bridges 12a, 12b of the base, in order to impart the circular translational movement sequence to the winding weight 14, as illustrated in FIGS. 9a to 9d.

Referring to FIG. 1, the height of the visible face of the two bridges 12a, 12b relative to the base 12 is substantially equal to the thickness of the two inertia masses 18a, 18b of the winding weight 14 to form two recessed volumes arranged on either side of the central part of the movement. The two inertia masses 18a, 18b can thus move within these two volumes in accordance with the circular translational movement of the winding weight 14.

The two counterweights 18a, 18b (FIGS. 4a and 4b) each have an outer face 19a intended to be mounted opposite a portion of the middle case of the watch case when the movement is mounted in the case, and an inner face 19b opposite the outer face. The inner face 19b of at least one of the inertia masses 18a, 18b comprises a recess 20, so that the winding weight 14 can partially and temporarily surround a component of the watch movement without coming into contact with it, particularly one or more gears 11, when a circular translational movement is imparted to the winding weight 14.

Preferably, at least one of the counterweights 18a, 18b includes a cutout 21 to form, together with the base 12, an opening for the passage of a control stem, particularly a winding or time-setting stem 80.

With reference to FIGS. 6 to 8, the automatic winding mechanism further comprises transmission means for winding the barrel 60 according to the circular translational movement of the winding weight 14. To this end, a gear train is engaged with the ratchet 70 of the barrel 60 and comprises a drive wheel 42 secured to a drive shaft 41, which is mounted on two bearings 41a, 41b and on which the fourth rotary arm 30a is fixed. The drive wheel 42 meshes with a conventional reverser 43, which comprises a first and a second clutch mobile 44, 45.

More specifically, the drive wheel 42 is in mesh with a clutch wheel 44a of the first clutch mobile 44. A clutch wheel 45a of the second clutch mobile 45 meshes with the clutch wheel 44a of the first mobile, while the pinions 44b (only the pinion of the first clutch mobile is visible in FIG. 6) of both clutch mobiles mesh with a first wheel 46 of a reduction gear train. The pinion of the first wheel 46 meshes with the wheel 47a of a second wheel 47, whose pinion 47b meshes with the ratchet 70 of the barrel to drive the rotation of the barrel shaft. The operation of this type of reverser is well known to those skilled in the art and will therefore not be described. However, it should be noted that the first and second clutch mobiles can be of various types, such as ratchet, ball, or spring mechanisms. A wolf tooth wheel 72, secured to the barrel shaft, cooperates with a pawl 74 located at the end of a leaf spring 76.

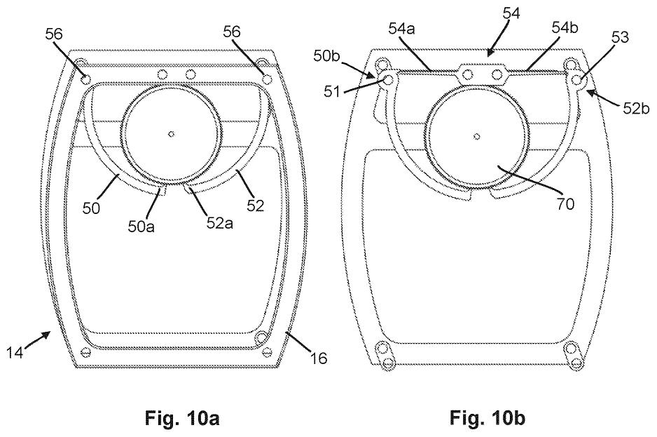

According to another embodiment illustrated in FIGS. 10a and 10b, the transmission means for winding the barrel according to the circular translational movement of the winding weight 14 comprise a pull lever 50 and a push lever 52. These two levers have, at a first end, a pawl 50a, 52a configured to respectively pull and push a tooth of the barrel ratchet 70 or a tooth of an intermediate wheel in mesh with the ratchet according to a non-illustrated variant.

Two of the four rotary arms are connected to an actuatable part 50b, 52b located at a second end of the pull lever 50 and the push lever 52 via a shaft 56 mounted through an opening 51, 53. This configuration allows the pull lever 50 and the push lever 52 to be actuated so that their respective pawls 50a, 52a pull and push a tooth of the barrel ratchet 70. As a result, the ratchet can be rotated in a single direction in response to the circular translational movement of the winding weight 14.

The frame 16 of the winding weight 14 comprises, on its lower face, at least one elastic member 54, which is, for example, in the form of two leaf springs 54a, 54b arranged to act on the actuatable part 50b, 52b of the pull lever 50 and of the push lever 52 to urge their respective pawls 50a, 52a against the barrel ratchet 70.

The operation of these transmission means according to this second embodiment is similar to a Pellaton-type mechanism, in which the eccentric is replaced by the two rotary arms.

Reference list

| | | |
|---|---|---|
| Watch movement 10 | | |
| Gears 11 | | |
| Base 12 | | |
| First and second bridges 12a, 12b | | |
| Winding weight 14 | | |
| Frame 16 | | |
| First and second fixing parts 16a, 16b | | |
| Counterbores 17 | | |
| First and second supports16c, 16d | | |
| First inertia mass 18a | | |
| Outer face 19a | | |
| Inner face 19b | | |
| Recess 20 | | |
| Second inertia mass 18b | | |
| Outer face 19a | | |
| Inner face 19b | | |
| Cutout 21 | | |
| Screw 22 | | |
| Bearing 23 | | |
| Arms 30a, 30b, 30c, 30d | | |
| Pivots 32 | | |
| Transmission means 40 | | |
| Drive shaft 41 | | |
| Bearings 41a, 41b | | |
| Drive wheel 42 | | |
| Reverser 43 | | |
| First clutch mobile 44 | | |
| Clutch wheel 44a | | |
| Pinion 44b | {close oversize brace} | first embodiment |
| Second clutch 45 | | |
| Clutch wheel 45a | | |
| First mobile 46 | | |
| Second mobile 47 | | |
| Wheel 47a | | |
| Pinion 47b | | |
| Pull lever 50 | | |
| Pawl 50a | | |
| Actuatable part 50b | | |
| Hole 51 | | |
| Push lever 52 | | |
| Pawl 52a | {close oversize brace} | second embodiment |
| Actuatable part 52b | | |
| Hole 53 | | |
| Elastic member 54 | | |
| Leaf springs 54a, 54b | | |
| Barrel 60 | | |
| Ratchet 70 | | |
| Wheel with wolf teeth 72 | | |
| Pawl 74 | | |
| Leaf spring 76 | | |
| Time-setting stem 80 | | |

1. Watch movement comprising in particular a base, a gear train, a barrel and an automatic winding mechanism for winding the barrel, the winding mechanism comprising a winding weight mounted in an articulated manner on the base by way of rotary arms so that the winding weight can perform a circular translation movement, the winding mechanism further comprising transmission means arranged to transmit the movement of the winding weight to the barrel, wherein the winding weight is connected to said rotary arms so as to constrain the circular translation movement of said weight in a plane parallel to the general plane of the watch movement, and wherein the rotary arms are free to pivot through 360°.

2. Watch movement of claim 1, further comprises comprising a frame connected to the winding weight or formed as a single piece with said weight, and wherein the rotary arms are pivotally connected to the frame, said rotary arms being arranged between the frame and the base.

3. Watch movement of claim 1, wherein the winding weight comprises an unbalance.

4. Watch movement of claim 2, wherein the frame comprises at least a first and a second fixing part to which the rotary arms are connected, and at least a first and a second support, each supporting an inertia mass, said inertia masses together forming the unbalance of the winding weight, said fixing parts and said supports being each arranged alternately on the frame around a central part of the watch movement.

5. Watch movement of claim 4, wherein the inertia masses are arranged on a single side of the frame.

6. Watch movement of claim 4, wherein said at least first and second fixing parts are each connected to the base by two arms of said rotary arms.

7. Watch movement of claim 4, wherein each inertia mass comprises an outer face intended to be mounted opposite a portion of the middle case of a watch case when the watch movement is mounted in said case, and an inner face opposite the outer face, the inner face of at least one of the inertia masses comprises a recess to partially surround at least one component of the watch movement, in particular a gear train, when a circular translational movement is applied to the winding weight.

8. Watch movement of claim 4, wherein at least one of the inertia masses comprises a cutout for the passage of a control stem, such as a time-setting stem.

9. Watch movement of claim 1, wherein the winding weight is articulated on the base via three or four rotary arms.

10. Watch movement of claim 1, wherein the winding weight comprises three inertia masses, each arranged between two rotary arms.

11. Watch movement of claim 1, wherein the transmission means comprise a gear train engaged with the barrel ratchet, at least one of the rotary arms being fixed to a drive shaft comprising a drive wheel in mesh with the gear train and arranged to be driven in rotation by the rotation of said at least one rotary arm.

12. Watch of claim 1, wherein the transmission means comprise a pull lever and a push lever, the pull and push levers comprising at a first end a pawl configured to alternately pull and push a tooth of the barrel ratchet or of a wheel in mesh with the barrel ratchet, in such a way that said barrel ratchet is driven in rotation in one direction only, each of the pull and push levers comprising a second end fixed to one of the rotary arms.

13. Watch movement of claim 12, wherein the winding weight comprises at least one elastic member acting on an actuatable part of the pull lever and of the push lever to urge their respective pawls against the barrel ratchet or said wheel.

14. Timepiece comprising the watch movement of claim 1.
